(19) United States
(12) Patent Application Publication
(10) Pub. No.: US 2022/0108577 A1
(43) Pub. Date: Apr. 7, 2022

(54) BIOMETRIC IDENTIFICATION SYSTEM

(71) Applicant: AMADEUS S.A.S., Biot (FR)

(72) Inventors: Mohamed-Amine MAAROUFI, Antibes (FR); Maite BAILET, Antibes (FR); Laurent CONJAT, Grasse (FR); Virginie VACCA THRANE, Valbonne (FR)

(21) Appl. No.: 17/459,335

(22) Filed: Aug. 27, 2021

(30) Foreign Application Priority Data
Oct. 5, 2020 (FR) 2010140

(51) Int. Cl. G07C 9/37; H04L 29/08

(52) U.S. Cl. CPC G07C 9/37; H04L 67/146; H04L 67/141

(57) ABSTRACT

A biometric identification computer system includes: a capture device configured to capture at least one first biometric data of a user, the first biometric data including a biometric feature; a biometric server configured to store the first biometric data and to generate an ID token for the user associated with the first biometric data; and at least one contact point communicatively coupled to the biometric server, each contact point configured to capture second biometric data of the user, the second biometric data comprising at least the biometric feature of the first biometric data; the biometric server being further configured to: compare the second biometric data with the first biometric data, retrieve the ID token, and allow the user to access contact point when the second biometric data corresponds to the first biometric data.

### CROSS-REFERENCE TO RELATED APPLICATION

This application claims priority from French Utility Model No. 2010140, filed Oct. 5, 2020, the contents of which is incoporated herein by reference.

### FIELD

The specification relates to a travel information management system that is configured to authenticate a traveler from their biometric data.

### BACKGROUND

Recognition systems make it possible to authenticate a person on the basis of their biometric references and identity. However, these systems operate independently of travel information. While these systems make it possible to simplify people's access through facial recognition, for example, they do not simplify other travel procedures such as, for example, the verification or printing of boarding passes. In addition, the biometric recognition systems that exist today are deployed in independent systems that do not communicate with each other. Thus, an individual's biometric data stored in one system is generally not reusable in another system using biometric recognition.

### SUMMARY

The specification sets out an architecture based on the creation of a unique ID Token that is assigned to a traveler. This ID token is associated with the biometric and identity data of a traveler for biometric recognition. In addition, the unique ID token is associated with the traveler's travel data. This dual association makes it possible to greatly simplify the processes of the traveler. Indeed, travel data can be retrieved and verified at any stage of a trip by the system, which frees the traveler from the constraint of repeatedly presenting a passport and/or boarding pass, for example. In addition, the architecture according to the specification aims at an ID token that is unique for each traveler and is reusable in other biometric systems which facilitates deployment and promotes scalability. The systems according to the specification may facilitate large-scale deployment by providing a secure application that allows each traveler to enlist and record their own biometric data.

Advantageously, biometric data and travel information are securely accessible in networks, which makes recognition possible across several systems.

The elements listed above are illustrative and non-limiting examples.

### BRIEF DESCRIPTIONS OF THE DRAWINGS

Other features and advantages of the invention will appear on reading the detailed description below presenting possible embodiments, and on examination of the accompanying drawings:

FIG. 1 shows a general structure of the architecture within the meaning of he invention.

FIG. 2 shows a functional architecture for interoperability.

FIG. 3 shows a functional architecture for enlistment.

FIGS. 4 and 5 show a functional architecture for the secure sharing of data.

FIG. 6 shows a system within the meaning of the present invention.

FIG. 7 shows a high-level architecture of the system within the meaning of the invention.

### DETAILED DESCRIPTION

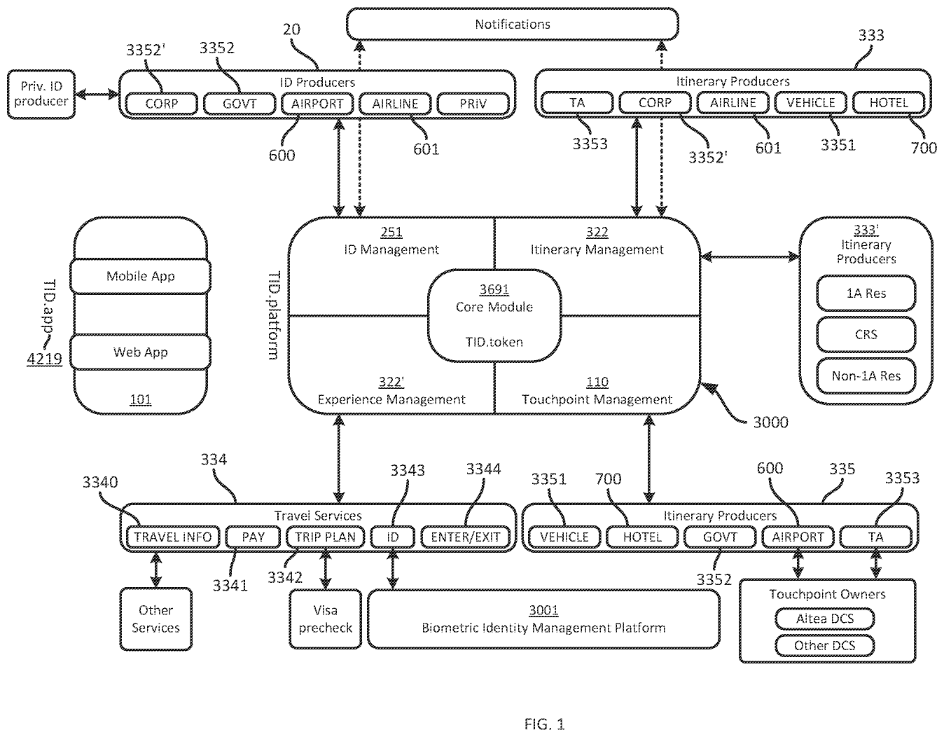

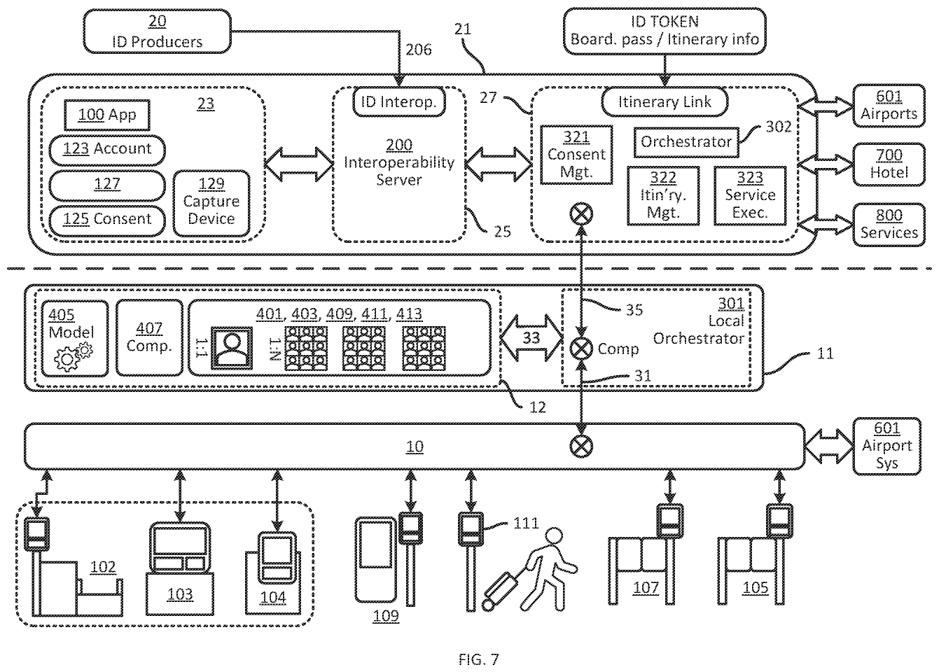

A general structure of the management architecture of biometric identifiers is shown in FIG. 1. The architecture includes a central platform (3000) adapted for the management of biometric identifiers such as an ID token. The ID token is, in an embodiment, linked to a traveler's itinerary. With reference to FIG. 1, an interface is shown that establishes the link between the ID token and for example the travel itinerary generated by a producer of travel itineraries. Each time a new itinerary is created, an update is made to associate the new itinerary with the ID token. Therefore this interface establishes a link between the ID token and a set of itineraries for the traveler. In one embodiment, the ID token is produced by a producer of digital identifiers (20, 3352′, 3352, 600, 601). In another embodiment, the ID token is created by a client application “TID.app” hosted on a terminal (101) of the traveler, The ID token will be used to identify the traveler at various touchpoints, The platform (3000) comprises an module (251) for identifier management (for example, management of the ID token), a module that includes travel itinerary management functions (322), a module (110) that includes a set of functions implementing an access layer (10), and a module for passenger experience management (322′). FIG. 1 illustrates a communication interface between the experience management module (322′; 3000) for management of the ID token, and a service platform (334). The functions of the modules (322) and (322′) can be performed by an orchestrator (302) shown in FIG. 7. The identifiers managed by the platform are used to identify the traveler and to facilitate the management of the traveler's itineraries and transactions. The ID token is used by the passenger experience management module (322′) to identify a set of experiences. For this purpose, the passenger experience management module (322′) of the platform has at least one communication interface with the travel services platform (334). Typically, the travel services platform (334) provides for example travel information services (3340), online payment (3341), and trip planning (3342). The ID token is used transparently to uniquely identify the traveler when the traveler accesses or uses different services (3340, 3341, 3342, 3343, 3344). The module (110) implementing the access layer (10) has at least one communication interface with platforms of owners and managers of capture devices (103, 105, 107, 109, 111; 102; 104). These capture devices (103, 105, 107, 109, 111; 102; 104) are located in airports (600) or travel agencies (3353) or hotels (700), or governmental organizations (3352), or even in vehicles (3351). The itinerary management module (322) has an interface with itinerary producers (333, 333′) such as travel agencies (3353), airlines (601), governmental or private organizations (3352, 3352′), hotels (700) or even vehicles (3351). The unique ID token is used in managing the traveler's movements. For example, the unique ID token of a given traveler is used to identify any route created for that traveler. For this purpose, the token that uniquely identifies the traveler associates the traveler with several routes created by various service providers such as travel agencies, airlines, hotels, vehicles.

Also shown in FIG. 1 is a communication interface between the identifier management module (251) (which manages, for example, the ID token) and an identifier provider (20). The identifier provider provides identifiers to private organizations (3352′) or government organizations (3352), airports (600), and airlines (601). The ID token can be produced by one of the producers of digital identifiers (3352, 3352, 600, 601). A description of the functions of the identifier providers is presented below.

With reference to FIG. 1, there is shown schematically a core module (3691) configured to coordinate transmission of an identifier of the traveler (for example, an identifier based on the ID token) between the different modules (251, 322, 110, 322′) of the central platform (3000).

FIG. 1 also shows a biometric identity management platform (3001) in communication with the travel services platform (334). The biometric identity management platform (3001) allows services to identify a given passenger using a biometric identifier created for that passenger. Typically, an identifier managed by this platform (3001) will be used to allow a traveler to access one or more services or to allow the traveler to carry out one or more service transactions (3340, 3341, 3342, 3343, 3343). Advantageously, the use of a biometric identifier managed in this way frees the traveler from the constraint of the use of paper identity documents. The functions of the platform (3001) may be provided for example by suppliers such as Gemalto™, ICM™, IN Group™, NEC™, Idemia™, Visionbox™ etc.

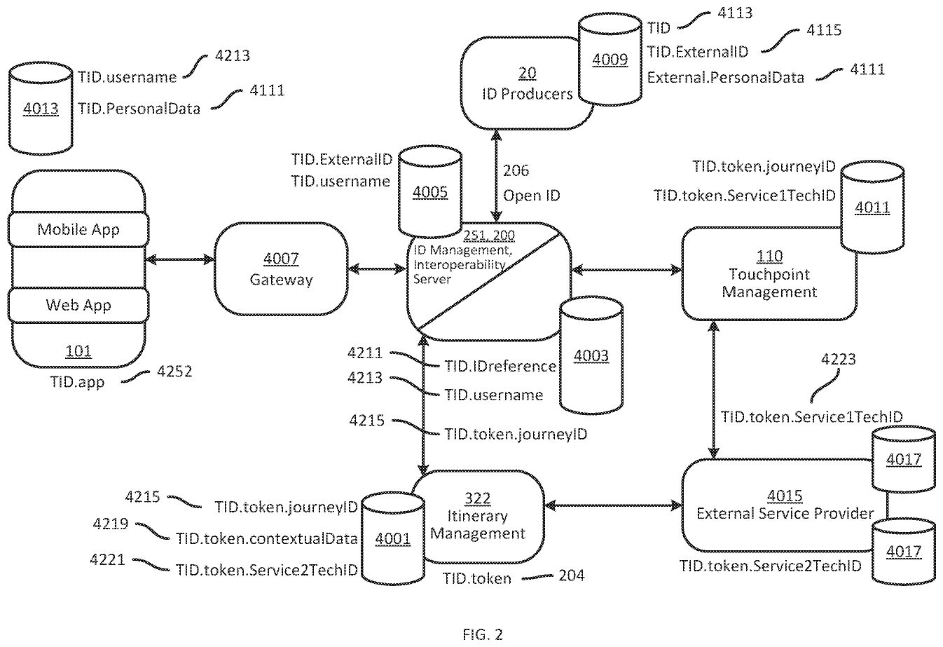

Referring to FIG. 2, a functional architecture is shown for implementing interoperability for a biometric identifier, and more particularly an ID token. The interoperability server (200) has an interoperability interface (206) to verify that the permanent ID token is unique and interoperable with other authentication systems. As illustrated in FIG. 2, the module (251) for managing the ID token is implemented within the interoperability server (200). The interoperability interface (206) is configured for pairing the module (251), which manages the ID token, to a biometric identity provider. In the example in FIG. 2, the biometric identity provider is a provider of ID tokens (20). In a very particular example, a provider of ID tokens is also a producer of ID tokens. The production of ID tokens can be carried out by some private providers.

With reference to FIG. 2, the interoperability interface (206) is configured to allow several producers and/or providers of ID tokens to connect securely to the interoperability server (200). Thus, several digital identity providers will be able to distribute ID tokens transparently and securely via the interoperability interface (206). A producer and/or provider of ID tokens can create an ID token from a traveler's personal data. A producer and/or provider of ID tokens will typically implement a database (4009) to store personal data (4111) of a traveler. The personal data (4111) of a passenger can also be stored in at least one other database (4013) outside the domain of a producer/supplier (20).

The personal data “External.PersonalData” (4111) may be derived from the traveler's passport information or any other document of the traveler's history. The producer and/or provider of ID tokens will create an ID token (4113) from this personal data (4111). Passport data is well suited for creating an ID token because the uniqueness of passport data favors the creation of a unique ID token for each traveler. Several ways can be implemented for the creation of a unique ID token for the traveler. The ID token can be stored in several forms, and in the example of FIG. 2, an ID token (4113) is stored in tandem with identity data “TID.ExternalID” (4115) and personal data (4111) of a passenger.

The ID token can be used by the module (251) to create several identifiers of the traveler. For example with reference to FIG. 2, the identifier “TID.IDreference” (4211) created by the management module (251) is a string of characters comprising a prefix in the form of the ID token or “TID” (4113) and a suffix including a reference identifier “IDreference.” The reference identifier of the traveler is for example generated by the management module (251).

Several other identifiers can also be created from the ID token to identify the traveler and the passenger's itinerary. For example, the identifier “TID.username” (4213) is created by the management module (251) and forms a string of characters with a prefix including the ID token or TID (4113) and a suffix including a username of the passenger. In addition, the travel itinerary identifier “TID.token.journeylD” (4215) is also created by the management module (251) and forms a string of characters with a prefix including the ID token or TID (4113) and a suffix including the character string “token.journeyID” identifying a route/itinerary of the passenger's journey. FIG. 2 shows a communication interface between the information management module (251, 200) and the itinerary management module (322). The identifiers that are managed by the ID management module are used within the itinerary management module (322). Other identifiers (4219; 4221) may be generated to identify information such as the traveler's contextual data or service data or the traveler's photos and videos. The interoperability architecture of FIG. 2 advantageously achieves decentralization of the creation of identifiers, since entities other than the initial producer (20) are able to create identifiers for the traveler. In addition, this architecture makes it possible to assign multiple identifiers, for various applications, to a single traveler from one ID token. This promotes the management of individual identifiers, with each identifier managed independently of the ID token. The uniqueness of each identifier is guaranteed by the uniqueness of the ID token because it is the root or prefix common to all other identifiers. This architecture also promotes scalability because new identifiers can be created depending on the application. The interoperability architecture of FIG. 2 implements one or more databases (4001, 4003, 4013) for the storage of these various identifiers.

In one embodiment, the functions for managing travel itineraries (322) and the functions of the management module (251) have access to the databases (4001; 4003) to user identifiers in the travel management of a given passenger.

As shown in FIG. 2, the travel itinerary identifier “TID.token.journeyID” (4215) and the service data identifier (4221) have been transmitted to a module (110) of the access layer (10). The travel itinerary identifier and service data identifier can be stored in a database (4011) accessible to the access layer (10). These identifiers will therefore be available to the multiple physical layers of the capture devices (103, 105, 107, 109, 111, 102, 104) presented above.

With reference to FIG. 2, the service data identifier (4221, 4223) can be used by the holder of the ID token to provide the holder with an external service (4015). A traveler having received an ID token (4113) assigned by the illustrated architecture can use a service data identifier (4221, 4223) derived from that ID token to identify the traveler to the service providers (4015). For example, the traveler can make a payment with the identifier (4223). In a particular embodiment, the service platform is configured to store the identifier (4223) in a secure database (4017). The use of the identifier (4223) facilitates the retrieval of user service data stored within the database (4017).

In an example implementation, an identifier “TID.app” (4252) is created and forms a string of characters with a prefix including the ID token or TID (4113) and a suffix including, for example, the string “app”. The identifier (4252) is intended to uniquely identify an application used by the user of the ID token. The applications thus identified are for example the applications integrated into an operating system such as Android(™) or other web-based applications. These applications are typically hosted on a user's terminal (101), As indicated above, the terminal (101) is communicatively coupled to a gateway (4007). Thus the terminal (101) of the user communicates with the module (251) for managing the ID token via the gateway (4007).

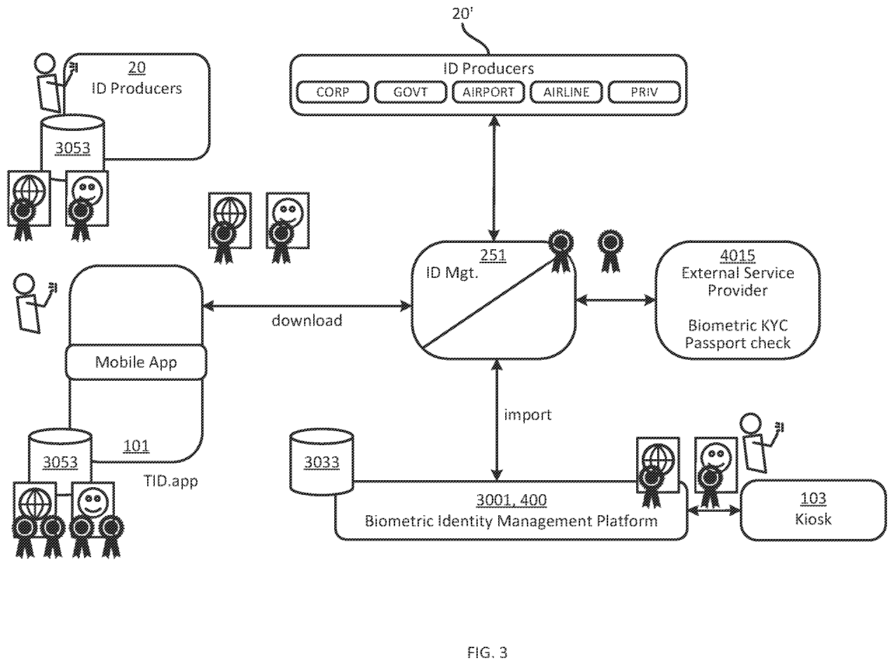

Referring to FIG. 3, an architecture for enlistment/registration according to the invention is illustrated. The role of this functional architecture is to enable a traveler to send their raw biometric data to a producer of biometric data. In a scenario, the user sends a “Selfie” photo for example to the producer (20). The producer (20) will generate at least one biometric identifier for the user from the raw data sent. The biometric identifier is then associated with the raw biometric data. The creation of a biometric identifier may be accompanied by the creation of an ID token by the producer of identifiers (20). In an example implementation, the producer of biometric identifiers also performs the functions of producer of ID tokens. It is contemplated that producers of digital identifiers will be able to create biometric identifiers for the identification of a traveler.

FIG. 3 illustrates a platform of the producer of identifiers (20′) communicatively coupled with a platform of the producer of biometric identifiers (20). There is provided a communication interface between at least one platform of producers of biometric identifiers (20, 20″) and the identifier management module (251).

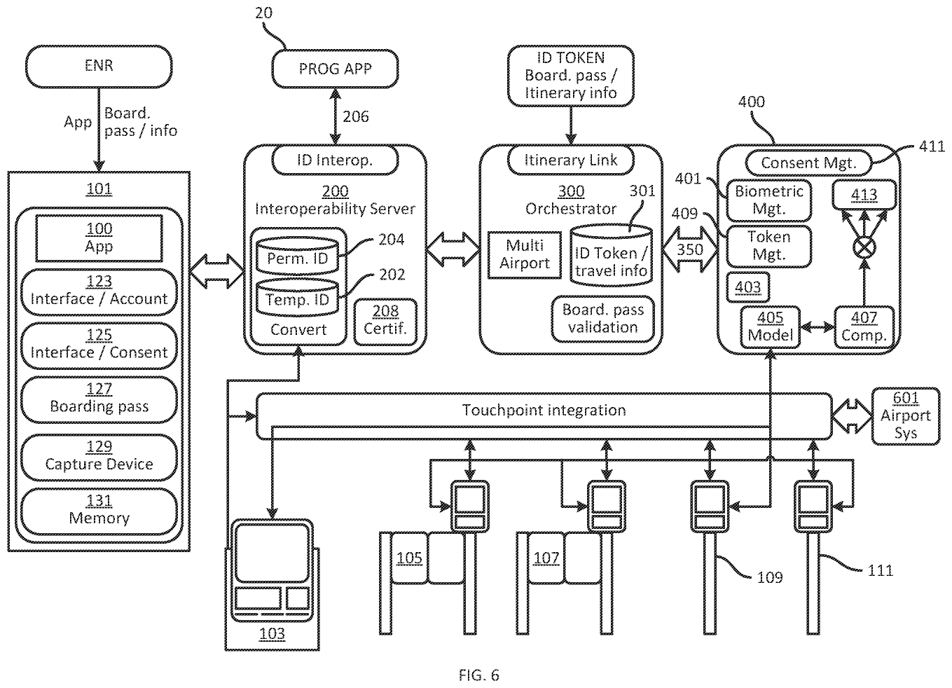

With continued reference to FIG. 3, there is a biometric identity management platform (3001) communicatively coupled to the module (251) for managing the ID token. For the purpose of carrying out enlistment registration, the raw biometric data of the user as described above, as well as the identifier associated with this raw biometric data, are stored in a server or a database (3033) of the biometric identity management platform (3001). In one embodiment this biometric identity management platform (3001) can be implemented within the biometric server (400) shown in FIG. 6.

In one embodiment, the enrollment includes the registration of the biometric data as well as the registration of the biometric identifier. This enrollment/registration can be initiated via a capture device such as the user's phone (101) or via a kiosk (103).

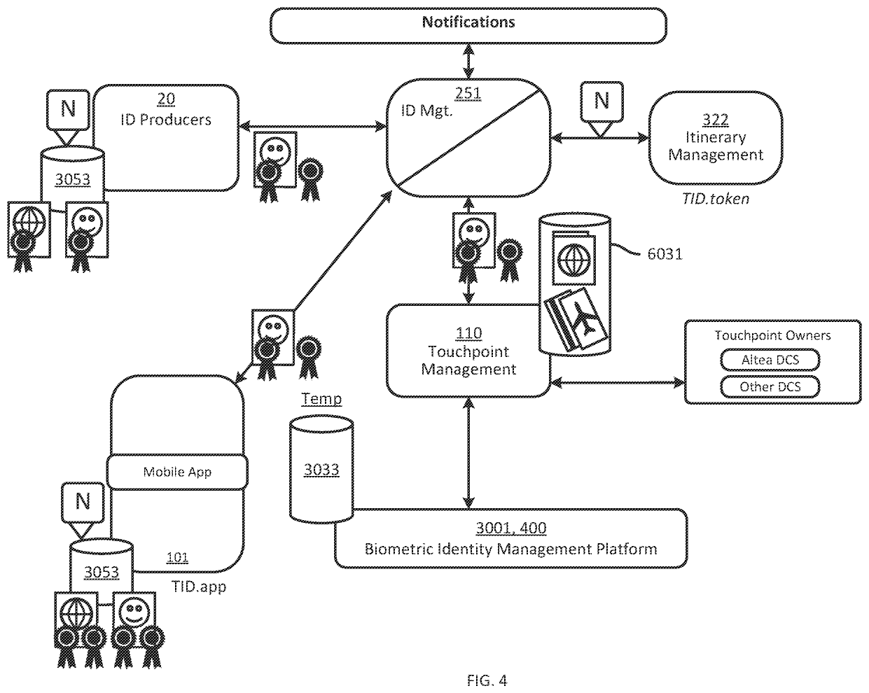

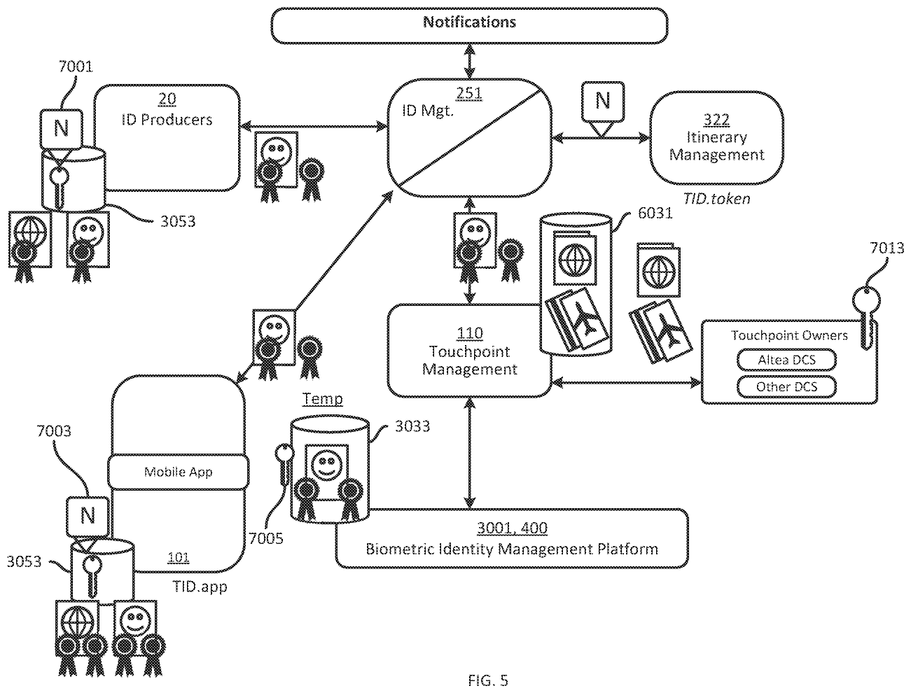

The architecture of FIGS. 4 and 5 implements security, transport and storage services for biometric data and biometric identifiers. This architecture also provides an environment to certify the security services used in the protection of biometric data and biometric identifiers. With reference to FIG. 5, security keys (7001) are shown, to ensure the confidentiality of ID tokens and/or biometric identifiers stored within a database (3053) of the producer (20). These keys are typically symmetric encryption keys shared with the other modules of the architecture (251, 110, 101, 322). Thus for example, an ID token and/or a biometric identifier transported from the producer platform (20) to the management module (251) is encrypted by an encryption key shared between the platforms of the producer and the management module. The architecture of FIGS. 4 and 5 allows the transport of biometric data and/or biometric identifiers from the device of a traveler (101) to the point of contact (110) or kiosk (103). Biometric identifiers are also transportable from an external identity provider/producer (20) to the point of contact (110) or kiosk (103).

Similarly, the identity data (ID tokens and/or biometric identifiers) are transported securely between the management module (251) and the other entities (for example a database (6031) affiliated with the module (110) of the access layer (10)). In addition, the biometric data and at least one identifier usable by an application of the user's device (101) are transported between the user's device (101) and the management platform (251) securely by means of an encryption key (7003).

The architecture of FIGS. 4 and 5 implements, in addition, memories (3033. 6031), e.g. RAM, aimed at storing data for a limited time. For example the database (3033), hosted within the biometric identity management platform, can be used to store data such as a temporary ID token (202). This data is also protected by encryption security services by means of an encryption key (7005). With reference to FIG. 5, the data stored in the database (6031) associated with the module (110) of the access layer (10) are also encrypted. It is contemplated that end-to-end encryption of data is implemented between the source of the data and the recipient of the data. For this purpose a symmetric encryption key will be used for the encryption of an identifier, for example “TID.app”, transported from the producer of identifiers (20) to the device of a traveler (101). Another encryption key will be used for the secure transport of other data between two entities of the architecture.

FIG. 6 illustrates an architecture comprising at least one capture device (101, 103, 105, 107, 109, 111), each configured for the capture of biometric data of travelers. There are two groups of capture devices. A first group includes all the dedicated capture devices (101, 103) that are used for the registration of biometric data. The second group includes all capture devices (105, 107, 109, 111) that are configured for biometric authentication from biometric data captured by the devices in the first group. The capture devices of the first group (101, 103) also make it possible to initiate the registration of biometric data. These dedicated devices (103) called point of contact or kiosk (103), or terminals (101) implement a secure application that communicates with a server of the system. The architecture implements a biometric server (400) intended to securely store the biometric data of travelers. The travel terminals/points of contact (105, 107, 109, 111) are adapted to authenticate the traveler by entering the biometric data of the traveler during travel. These capture provisions therefore ensure that the biometric data captured by the traveler match the previously recorded data. These devices (105, 107, 109, 111) can be deployed at points where traveler authentication is required, such as at airport security and access gates.

In one embodiment, the capture device (101, 103) is connected to the biometric server (400) by a secure Virtual Private Network (VPN) link for example.

In a scenario, the capture terminal (101) may be a computer, mobile phone or other device reserved for the traveler's personal use.

Typically, such a capture device has a scanner or camera (129) for biometric data capture. The biometric data thus entered can be stored locally in a memory (131) of the device. A traveler can use their mobile phone to, for example, take a photo that will later be transformed into biometric reference data. The biometric reference data is biometric data that will be recorded in the system and used to recognize the traveler.

Still with reference to FIG. 6, the functionality of the capture device is discussed below. There is provision for an application (100) client for the management of biometric references of the traveler. This application (100) can be installed locally on the device or on a remote server and accessible through an interface (123, 125). It is a Software as a Service (SaaS)-like computer application that can be compatible with a web browser for example. This application can be implemented using a software development kit that facilitates implementation on multiple operating systems. The traveler can thus, through this application (100), access an account (123) to manage their biometric references. In particular the application (100) has an interface (125) that allows the user to give their consent for the registration of their biometric data. The app also allows the traveler to withdraw their consent. The consent agreement or withdrawal of consent is recorded by a consent management module (411) on the biometric server (400).

In a data capture scenario with reference to FIG. 6, for example, the traveler will launch the application and take a picture of themselves or make a video of their face for a predetermined period.

Raw data in the form of a photo or video is then created and stored on the device in an appropriate format (e.g. JPEG, TIFF, PNG, PDF, PSD, RAW; MPEG-1, 2, 4, 7, Div X; QuickTime(™), RealVideo(™), Windows Media(™), etc.).

In a preferred embodiment, the data captured in the raw state by the device is sent securely to the biometric server (400). The data in the raw state is thus stored securely in a memory (403) of the biometric server (400).

In the preferred embodiment, the biometric server (400) generates an identifier (an ID token) that will uniquely identify the traveler. Several ways can be implemented for the creation of the ID token. From its inception, the ID token is associated with the traveler and the traveler's biometric data.

In order to create a biometric reference, the biometric server (400) converts the raw data of the traveler into a biometric model (405) which is also stored on the biometric server (400).

The ID token, which has the role of uniquely identifying the traveler, is associated with both the traveler's data and the biometric model created from this raw data. A management entity (409) hosted on the biometric server associates the ID token with the raw data (403) of the traveler and the biometric model (405).

Subsequently, any data comprising at least one such biometric model stored on the server (400) may be referred to as biometric reference data. When the traveler's biometric data is securely posted in the biometric server (400),the traveler's enlistment step is completed.

Several biometric data can be stored for a single traveler identifiable by an ID token, and this data is stored in a unit (413) of the biometric server (400).

In one embodiment the ID token can be generated before enrollment, and therefore before or at the time of enrollment, the recording of the biometric reference data can be associated with the traveler.

In practice, a traveler can initiate the enrollment phase for the reference biometric data via the application presented above from a laptop or one of the dedicated capture devices. For example, the traveler can initiate enlistment at a point of contact or a kiosk (103) or a registration station equipped with a dedicated capture device. This enlistment step can be done at the time the traveler arrives at an airport or at the time the traveler registers their luggage. The traveler may also make this enrollment at home before their trip.

The enrollment process will now be described, which includes the recording of biometric data and information from an identity document. The traveler's raw biometric data is recorded in a manner described above and the traveler's identity information is also obtained from an identity document such as a passport or identity card. In one embodiment the capture device (103) also comprises a document reader such as a scanner for capturing and recording passport information in digital form.

In practice, a dedicated capture device (103) available to the general public can implement, by means of a computer program, the functions of capturing raw biometric data and reading identity documents. In a scenario, such a device is equipped with a touch interface, a camera and a scanner. This device can be a device of the type Common Use Terminal Equipment (CUTE) implementing for example Paxtrack(™) programs, e.g. from Resa(™).

In an embodiment, the biometric data is created from the raw biometric data and identity information obtained from a passport for example. Various mathematical functions are contemplated to combine this information and create unique and secure biometric data for the traveler. For example, hash functions such as Message Digest Algorithm 5 (MD5) or Secure Hashing Algorithm (SHA)-2, SHA-3, are well suited since they produce an output value called a fingerprint or hash value from which it is impossible to calculate the input data. Such cryptographic functions are well suited to protect the security of raw biometric data and passport information.

In one embodiment, the ID token is created by means of a mathematical hash function and from the raw biometric data and/or passport information data. Several means and methods can be implemented for the creation of a unique ID token for the traveler.

With reference to FIG. 6, the means used for authentication of a traveler when a traveler presents at one of the crossing devices or points of contact (105, 107, 109, 111) will be described. These devices are part of the devices in the second group (105, 107, 109, 111).

This authentication according to the invention is not limited to facial recognition and can also be applied to fingerprint recognition.

It is assumed that a traveler has already participated in the enrollment process described above. Therefore, the traveler's biometric data is already stored at the biometric server (400) and the traveler already has an ID token, which is associated with the traveler's reference biometric data, A management module (401) is provided in the biometric server (400) to associate the ID token with the biometric reference data of the traveler.

A capture device of the second group (105, 107, 109, 111) will obtain raw biometric data, for example a digital image of the traveler's face in a manner described above. The capture device is adapted to associate this raw data of the traveler with the ID token assigned to the traveler during enrollment,

This raw data is sent with the ID token, encrypted, to the biometric server (400).

The biometric server (400) converts this raw data into biometric data by the conversion means implemented by the module (405), presented above. The biometric server (400) uses the ID token to retrieve the reference biometric data stored for the traveler during the enrollment phase. The server (400) compares the captured biometric data to the reference biometric data stored for the traveler. The server (400) verifies that this captured biometric data associated with the ID token corresponds to the reference biometric data stored for the traveler.

The comparison is performed by a comparison module (407) using mathematical functions for comparing patterns, for example.

When the comparison indicates that the biometric data received in association with the ID token corresponds to the reference biometric data stored for the same ID token, the biometric server sends a success message to the capture device (103, 105, 107, 109, 111).

Thus the capture device (103, 105, 107, 109, 111) receives confirmation from the biometric server that the traveler is authenticated.

Advantageously, this biometric authentication method enables the traveler to avoid the need to present a passport or an identity card each time they pass a contact point (103, 105, 107, 109, 111) where their identity must be verified.

If the capture device is associated with an access point such as a door, the authentication of a traveler according to the method described above can automatically trigger the opening of the door to allow passage by the traveler.

In airports for example, an architecture according to the invention enables a significant reduction in time required to traverse gates and for boarding processes (105, 107, 109, 111).

The authentication of people by biometric data makes it possible to improve the fluidity of the flow of people at an access door, for example.

Advantageously, the system according to the invention is easily deployable. Deployment includes updating capture devices (101, 103, 105, 107, 109, 111) with programs capable of executing the instructions of the application according to the invention. Following the enrollment process, the architecture allows the traveler to be authenticated from any point connected to the biometric server (400). Thus, the biometric authentication system according to the invention is ubiquitous.

The architecture according to the invention offers greater flexibility of deployment because ordinary devices such as portable phones can be used for the enrollment and registration of biometric reference data.

Stored biometric reference data can be transferred securely between multiple platforms. Thus, the traveler need not re-enroll each time they visit a new platform when their biometric data has already been transferred before their trip.

An example creation of a unique ID token assigned to the traveler during the enrollment phase will now be discussed, according to an embodiment.

In one embodiment, a dedicated capture device is capable of generating a temporary ID token (202) during the enrollment phase for example. The interop server (200) will convert the temporary ID token into a permanent ID token (204) for the traveler. This conversion ensures that the permanent ID token is unique and can be reused by other recognition systems. The interoperability server thus has an interoperability interface (206) to verify that the permanent ID token is unique and interoperable with other authentication systems. For this purpose, the interoperability server has a certification entity (208) which is able to certify the origin of the ID token.

With reference to FIG. 6, the interoperability interface (206) is configured to be communicatively paired with an ID token provider (20).

The unique ID token makes data management easier because the unique ID token is associated with both the traveler's biometric data and travel information. For example, one might consider an application that associates a set of a traveler's travel data with the ID token. By also using the association between the ID token and the traveler's biometric data, the traveler's identity can be traced or verified. This double association can also be reused to securely offer various applications and services to the traveler in view of their previous trips.

The ID token that uniquely identifies the traveler can be reused several times to associate the traveler with their different trips.

A function for managing the traveler's travel information is now described. The system according to the invention provides an orchestrator server (300) which stores travel information such as boarding pass information and/or stages in a travel itinerary. In one embodiment, this server (300) also associates the travel information of a traveler to the ID token of the traveler. For example, a lookup table (301) can be provided to associate the traveler's travel information with the ID token assigned to them. The ID token of the traveler is available to the orchestrator (300) because the latter has established a secure communication interface (350) with the biometric server (400), In practice the functions of the orchestrator (300) can be performed by the biometric server or by another server separate from the biometric server.

The orchestrator function makes it possible to retrieve travel information (e.g. the boarding pass) each time a capture device verifies the identity of a traveler in the manner presented above.

Advantageously, this function allows the traveler to progress in an airport for example without being required to carry a boarding pass, because it may be available at any point of contact where identity verification according to the invention is feasible. In some scenarios, the boarding pass may be printed only at the time of access to the aircraft, eliminating the risk of misplacing the boarding pass.

In an example scenario according to an embodiment, the traveler can trigger the retrieval of their boarding pass by means of a module (127) of the application (100) using the “ID token”. The module (127) also represents travel management features such as, for example, itinerary management functions.

When the functions of the orchestrator and the biometric server are combined, the architecture according to the invention improves the security and fluidity of the flow of travelers. When the traveler transitions to a point of contact (105, 107, 109, 111), the traveler will be automatically authenticated by their biometrics and the assigned ID token is used to retrieve the travel information. Thus the traveler need not repeatedly present a passport and/or a boarding pass, which significantly reduces waiting times.

With reference to FIG. 7, a high-level functional architecture corresponding to the architecture of FIG. 6 is shown. Reference is made to both FIGS. 6 and 7 below. FIG. 7 shows an access layer (10), a first layer of services (11) and a second layer of services (21), and interfaces (31, 35) of communications between these layers. The functions of the biometric server are presented in the first layer of services (11) which is located between the second layer of services (21) and the access layer (10). The access layer (10) is common to several capture devices (103, 105, 107, 109, 111) and/or recording devices (102, 104). The access layer lies between the multiple physical layers of the devices (103, 105, 107, 109, 111, 102, 104) of the architecture and the first layer of services (11) which includes biometric functions. The access layer (10) allows biometric functions and travel data management functions (301, 302) to have direct access to physical devices (102, 103, 104, 105, 107, 109, 111). A communication interface (31) is configured for the processing of data between the devices and the first layer of services (11).

With reference to FIG. 7, the first layer of services (11) comprises a first block (12) of biometric functions and a second block of local functions of the orchestrator (301). The orchestrator's local function block is the set of orchestrator functions (301, 302) that are performed and used at a given airport.

The biometric service blocks (12) and local functions (301) of the orchestrator communicate with each other via an interface (33). This interface enables combination of the functions of the first block (12) of the biometric server and the local functions of the orchestrator (301). Thus the interface (33) is configured to integrate the biometric authentication functions and the travel data management functions available locally,

As indicated above, data captured by a dedicated device such as a contact point or kiosk (103), or a terminal (101), can be sent securely to the biometric function block (12) via the interface (31). Recall that the biometric functions (12) are implemented on the biometric server (400) presented in FIG. 6. The biometric functions block (12) represents all biometric authentication functions including the comparison and verification of biometric data as described above.

The blocks (401 403, 409, 411, 413) of FIG. 7 represent the functions of the management and memory entities of the biometric server (400) of FIG. 6 having the same reference numbers. Biometric functions can control an access device by sending a command to that device via the interface (31). For example, when a capture device is associated with an access point such as a door (105, 107, 109, 111), the authentication of a traveler according to the method described above can automatically trigger the opening of the door.

With reference to FIG. 7, the second layer (21) of services comprises at least a first block of the services for enrollment (23), and a second block of the services for the management of interoperability (25). These services can for example be implemented by the enrollment application (100) and by the interoperability server (200) described above.

The second service layer (21) also comprises a third block of services (27) representing part of the functions of the orchestrator (300). This block includes travel management functions including travel itinerary management (322). It also includes a set of service execution functions (323). This third functional block is coupled operationally to the local functions block of the orchestrator (301). FIG. 7 shows a coupling interface (35) between the two blocks of the orchestrator. Thus traveler data stored locally within an airport for example can be made available to services for enrollment (23) and interoperability (25). In addition, the results of biometric authentication operations are made available to the other enrollment (23) and interoperability functions (25) by the orchestrator functions (301, 302, 300).

The functions of the second layer of services (21) are accessible and available in networks to various other platforms. For example, the functions of this layer may be available at other airports (600), hotels (700), or other types of service providers (800). The service layer (21) is configured to communicate with these other platforms via the functional block of the orchestrator (302). For example, information related to the authentication of a traveler and/or the travel data of a traveler can be transferred securely from this functional block (302) to other platforms (600, 700, 800) and vice versa. The sharing of locally stored biometric data is also contemplated, if such sharing is carried out securely. This sharing of information is of course subject to the consent of the user. For this purpose, consent management functions (321) are provided to the user within the orchestrator (302, 300). This sharing of information allows other systems such as hotel reservation systems (700) to benefit from information of the traveler present on the architecture within the meaning of the invention. In addition, the sharing of information about biometric data allows the traveler to avoid having to re-enroll when visiting a new platform. When biometric data is previously transferred, the traveler can save time by avoiding the biometric enrollment phase each time they visit one of the partner airports (600, 601).

The scope of the claims should not be limited by the embodiments set forth in the above examples, but should be given the broadest interpretation consistent with the description as a whole.

1. A biometric identification system comprising:
a capture device configured to capture at least one first biometric data of a user, the first biometric data including a biometric feature;
a biometric server configured to store the first biometric data and to generate an ID token for the user associated with information of the user; and
at least one contact point communicatively coupled to the biometric server, each contact point configured to capture second biometric data of the user, the second biometric data comprising at least the biometric feature of the first biometric data;
the biometric server being further configured to:
compare the second biometric data with the first biometric data,
retrieve the ID token, and
allow the user to access the contact point when the second biometric data corresponds to the first biometric data.

2. The biometric identification system of claim 1, comprising:
a first layer of services implementing at least the biometric server;
a second layer of services implementing at least (i) an application, (ii) an interoperability server, and (iii) an orchestrator; and
an access layer for coupling the capture device and at least one contact point to at least one of the first layer of services and the second layer of services.

3. The biometric identification system of claim 2, wherein the application is configured to manage at least one of: (i) capturing biometric data, and (ii) recording the biometric data.

4. The biometric identification system of claim 2, wherein the interoperability server is communicatively coupled to the application, and wherein the interoperability server is configured to manage the ID token for the user.

5. The biometric identification system of claim 2, wherein the orchestrator is communicatively coupled to the biometric server and to the interoperability server; and
wherein the orchestrator is configured to manage the information of the user.

6. The biometric identification system of claim 2, wherein the orchestrator is configured to associate the ID token with the information of the user.

7. The biometric identification system of claim 1, further comprising a registration user interface accessible to the user via the capture device; the interface being configured to receive the first biometric data from the user.

8. The biometric identification system of claim 1, wherein the biometric server is configured to retrieve the ID token and the information of the user when the second biometric data corresponds to the first biometric data.

9. The biometric identification system of claim 1, wherein the capture device includes at least one of (i) a scanner, and (ii) a camera.
